(19) United States
(12) Patent Application Publication
(10) Pub. No.: US 2025/0290424 A1
(43) Pub. Date: Sep. 18, 2025

(54) METALLIC BLADE SPAR RETENTION SYSTEM

(71) Applicant: General Electric Company, Schenectady, NY (US)

(72) Inventors: Nicholas J. Kray, West Chester, OH (US); Nicholas M. Daggett, Camden, ME (US)

(21) Appl. No.: 18/607,030

(22) Filed: Mar. 15, 2024

(51) Int. Cl. F01D 5/32; F01D 7/00

(52) U.S. Cl. CPC F01D 5/32; F01D 7/00; F05D 2220/36; F05D 2260/31; F05D 2260/79

(57) ABSTRACT

Systems, apparatus, articles of manufacture, and methods are disclosed to attach a airfoil to a hub for pitch-controlled actuation, comprising: a spar as a portion of a base of the airfoil; a trunnion coupled to the hub, the trunnion to receive the spar; the spar positioned with respect to the trunnion so that a portion of the airfoil having a length greater than a diameter of the airfoil is retained within the trunnion to react a moment through the length of the airfoil retained within the trunnion; a split ring around an inside of the trunnion, the split ring aligned with a notch on the airfoil, the notch on the airfoil shaped to allow the split ring to move towards a airfoil of the trunnion; and a nut removably coupled to the trunnion, the nut positioned to prevent the split ring from moving away from a base of the trunnion.

### FIELD OF THE DISCLOSURE

This disclosure relates generally to an airfoil assembly and, more particularly, to an airfoil assembly.

### BACKGROUND

Turbine engines, and particularly gas or combustion turbine engines, are rotary engines that extract energy from a flow of gases passing through a fan with a plurality of fan blades, then into the engine through a series of compressor stages, which include pairs of rotating blades and stationary vanes, through a combustor, and then through a series of turbine stages, which include pairs of rotating blades and stationary vanes. The blades are mounted to rotating disks, while the vanes are mounted to stator disks.

During operation, air is drawn into the compressor section through the fan section where it is then pressurized in the compressor and mixed with fuel in the combustor for generating hot combustion gases which flow downstream through the turbine stages where the air is expanded and exhausted out an exhaust section. The expansion of the air in the turbine section is used to drive the rotating sections of the fan section and the compressor section. The drawing in of air, the pressurization of the air, and the expansion of the air is done, in part, through rotation of various rotating blades mounted to respective disks throughout the fan section, the compressor section and the turbine section, respectively. The rotation of the rotating blades imparts mechanical stresses along various portions of the blade; specifically, where the blade is mounted to the disk.

### BRIEF DESCRIPTION OF THE DRAWINGS

FIG. 1 is a schematic cross-sectional view of a turbine engine in accordance with an exemplary embodiment of the present disclosure.

FIG. 2 is a schematic illustration of an airfoil assembly suitable for use within the turbine engine of FIG. 1, the airfoil assembly including an airfoil, a trunnion, and a spar.

FIG. 3 is a schematic cross-sectional view of the airfoil assembly as seen from sectional line III-III of FIG. 2, further illustrating a furcated tail of the spar having a set of branches defining an intervening gap, the airfoil assembly having a wedge received within the intervening gap.

FIG. 4 is a schematic illustration of a pitch control assembly to retain a metallic spar in accordance with the teachings of this disclosure.

FIG. 5 is a schematic illustration of a first trunnion assembly retention system of FIG. 4 in accordance with the teachings of this disclosure.

FIG. 6 is a schematic illustration of a second trunnion assembly retention system of FIG. 4 in accordance with the teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Open rotor engines, or unducted fans, generate thrust without an encasement of the engine. The open rotor engine draws in and compresses air, which subsequently passes through the open rotor. Rapid propeller rotation accelerates the air, leading to thrust generation for flight. To realize potential fuel savings, open rotor engines make use of fan blade pitch control mechanisms, which allow for pitch controlled actuation of a fan blade to actuate the fan blade during the various stages of flight.

Aspects of the disclosure herein are directed to an airfoil assembly for a turbine engine. The airfoil assembly includes an airfoil and a trunnion. In some examples, an airfoil is referred to as a means for generating lift. The base of the airfoil includes a spar, also known as a blade root, which provides structural support to the airfoil and carries flight loads. In some examples, the spar may be referred to as a means supporting. The spar bears the weight of the airfoil while the aircraft is on the ground. The airfoil assembly, specifically the spar, is retained within the trunnion through the wedge. In some examples, the trunnion is referred to as a means for accepting an airfoil. For purposes of illustration, the present disclosure will be described with respect to an airfoil assembly for a turbine engine, specifically where the airfoil is a fan blade of the turbine engine. It will be understood, however, that aspects of the disclosure described herein are not so limited and can have general applicability within other engines or within other portions of the turbine engine. For example, the disclosure can have applicability for an airfoil assembly in other engines or vehicles, and can be used to provide benefits in industrial, commercial, and residential applications.

The term “metallic” as used herein is indicative of a material that includes metal such as, but not limited to, titanium, iron, aluminum, stainless steel, and nickel alloys. A metallic material or alloy can be a combination of at least two or more elements or materials, where at least one is a metal.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, adjacent, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows. However, the terms “upstream” and “downstream” as used herein may also refer to a flow of electricity.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

In some turbine engines, a variable pitch airfoil can be included, which can be selectively rotated to adjust or otherwise tailor the flow of fluid over the variable pitch airfoil. The variable pitch airfoil is movable through use of a trunnion and a spar. The trunnion can rotate about a rotational axis, which in turn rotates the spar and the variable pitch airfoil. The trunnion is coupled to or otherwise formed with the spar, which is the base of the airfoil.

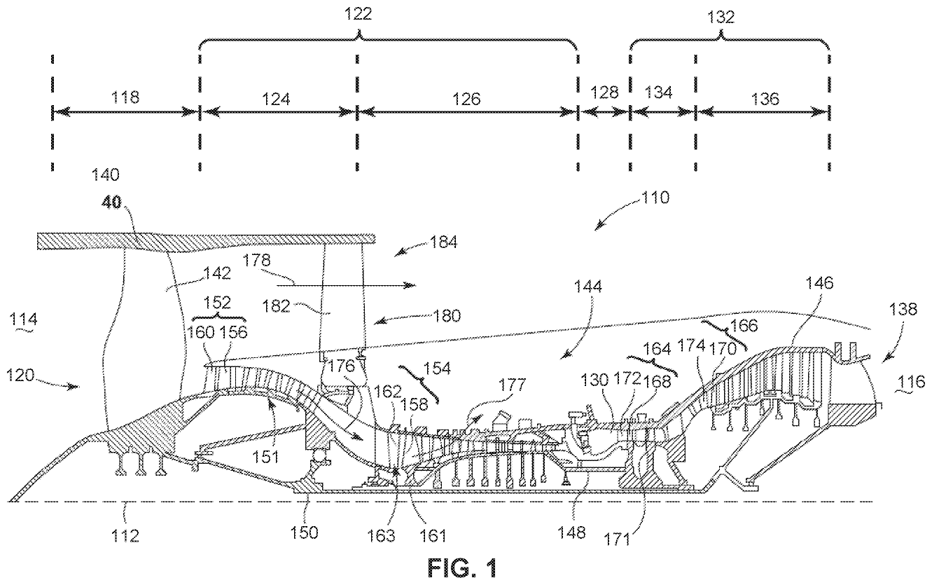

FIG. 1 is a schematic cross-sectional diagram of a turbine engine 110 for an aircraft. The turbine engine 110 has a generally longitudinally extending axis or centerline 112 extending forward 114 to aft 116. The turbine engine 110 includes, in downstream serial flow relationship, a fan section 118 including a fan 120, a compressor section 122 including a booster or low pressure (LP) compressor 124 and a high pressure (HP) compressor 126, a combustion section 128 including a combustor 130, a turbine section 132 including an HP turbine 134, and an LP turbine 136, and an exhaust section 138.

The fan section 118 includes a fan casing 140 surrounding the fan 120. The fan 120 includes a plurality of fan blades 142 disposed radially about the engine centerline 112. The HP compressor 126, the combustor 130, and the HP turbine 134 form an engine core 144 of the turbine engine 110, which generates combustion gases. The engine core 144 is surrounded by a core casing 146, which can be coupled with the fan casing 140.

An HP shaft or spool 148 disposed coaxially about the engine centerline 112 of the turbine engine 110 drivingly connects the HP turbine 134 to the HP compressor 126. An LP shaft or spool 150, which is disposed coaxially about the engine centerline 112 of the turbine engine 110 within the larger diameter annular HP spool 148, drivingly connects the LP turbine 136 to the LP compressor 124 and fan 120. The spools 148, 150 are rotatable about the engine centerline and couple to a plurality of rotatable elements, which can collectively define a rotor 151.

The LP compressor 124 and the HP compressor 126 respectively include a plurality of compressor stages 152, 154, in which a set of compressor blades 156, 158 rotate relative to a corresponding set of static compressor vanes 160, 162 to compress or pressurize the stream of fluid passing through the stage. In a single compressor stage 152, 154, a plurality of compressor blades 156, 158 can be provided in a ring and can extend radially outward relative to the engine centerline 112, from a blade platform to a blade tip, while the corresponding static compressor vanes 160, 162 are positioned upstream of and adjacent to the rotating compressor blades 156, 158. It is noted that the number of blades, vanes, and compressor stages shown in FIG. 1 were selected for illustrative purposes only, and that other numbers are possible.

The compressor blades 156, 158 for a stage of the compressor can be mounted to (or integral to) a disk 161, which is mounted to the corresponding one of the HP and LP spools 148, 150. The static compressor vanes 160, 162 for a stage of the compressor can be mounted to the core casing 146 in a circumferential arrangement.

The HP turbine 134 and the LP turbine 136, respectively, include a plurality of turbine stages 164, 166, in which a set of turbine blades 168, 170 are rotated relative to a corresponding set of static turbine vanes 172, 174, also referred to as a nozzle, to extract energy from the stream of fluid passing through the stage. In a single turbine stage 164, 166, a plurality of turbine blades 168, 170 can be provided in a ring and can extend radially outward relative to the engine centerline 112 while the corresponding static turbine vanes 172, 174 are positioned upstream of and adjacent to the rotating turbine blades 168, 170. It is noted that the number of blades, vanes, and turbine stages shown in FIG. 1 were selected for illustrative purposes only, and that other numbers are possible.

The turbine blades 168, 170 included in a stage of the turbine, can be mounted to a disk 171, which is mounted to the corresponding one of the HP and LP spools 148, 150. The turbine vanes 172, 174 included in a stage of the compressor can be mounted to the core casing 146 in a circumferential arrangement.

Complementary to the rotor portion, the stationary portions of the turbine engine 110, such as the static vanes 160, 162, 172, 174 among the compressor and turbine sections 122, 132 are also referred to individually or collectively as a stator 163. As such, the stator 163 can refer to the combination of non-rotating elements throughout the turbine engine 110.

In operation, the airflow exiting the fan section 118 is split such that a portion of the airflow is channeled into the LP compressor 124, which then supplies a pressurized airflow 176 to the HP compressor 126, which further pressurizes the air. The pressurized airflow 176 from the HP compressor 126 is mixed with fuel in the combustor 130 and ignited, which generates combustion gases. Some work is extracted from these gases by the HP turbine 134, which drives the HP compressor 126. The combustion gases are discharged into the LP turbine 136, which extracts additional work to drive the LP compressor 124, and the exhaust gas is ultimately discharged from the turbine engine 110 via the exhaust section 138. The driving of the LP turbine 136 drives the LP spool 150 to rotate the fan 120 and the LP compressor 124.

A portion of the pressurized airflow 176 can be drawn from the compressor section 122 as bleed air 177. The bleed air 177 can be drawn from the pressurized airflow 176 and provided to engine components requiring cooling. The temperature of pressurized airflow 176 entering the combustor 130 is increased above the bleed air temperature. The bleed air 177 may be used to reduce the temperature of the core components downstream of the combustor 130. The bleed air 177 can also be utilized by other systems.

A remaining portion of the airflow, referred to as a bypass airflow 178, bypasses the LP compressor 124 and engine core 144 and exits the turbine engine 110 through a stationary vane row, and more particularly an outlet guide vane assembly 180, comprising a plurality of airfoil guide vanes 182, at a fan exhaust side 184. More specifically, a circumferential row of radially extending airfoil guide vanes 182 are utilized adjacent the fan section 118 to exert some directional control of the bypass airflow 178.

Some of the air supplied by the fan 120 can bypass the engine core 144 and be used for cooling portions, especially hot portions, of the turbine engine 110, and/or used to cool or power other aspects of the aircraft. In the context of a turbine engine, the hot portions of the engine are normally downstream of the combustor 130, especially the turbine section 132, with the HP turbine 134 being the hottest portion as it is directly downstream of the combustion section 128. Other sources of cooling fluid can be, but are not limited to, fluid discharged from the LP compressor 124 or the HP compressor 126.

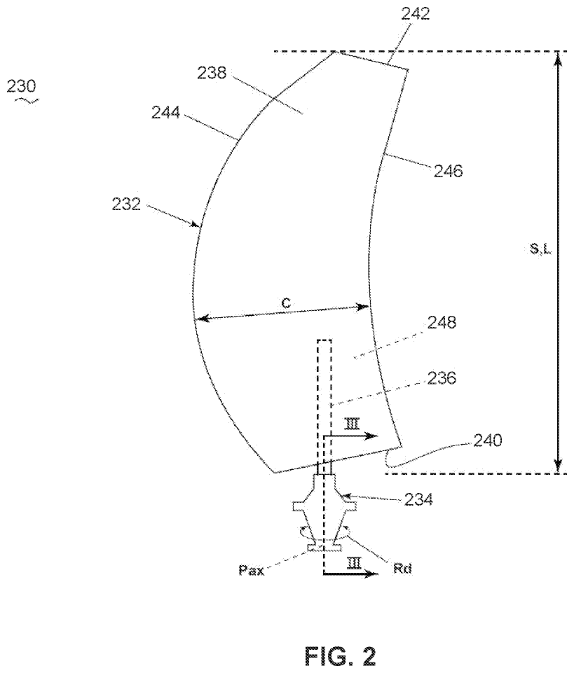

FIG. 2 is schematic illustration of an airfoil assembly 230 suitable for use within the turbine engine 110 of FIG. 1. The airfoil assembly 230 can include an airfoil 232 that is any suitable airfoil of the turbine engine 110. As a non-limiting example, the airfoil 232 can be a blade of the plurality of fan blades 142, or a blade from the compressor blades 156, 158 or the turbine blades 168, 170. It is contemplated that the airfoil 232 can be a blade, vane, airfoil, or other component of any turbine engine, such as, but not limited to, a gas turbine engine, a turboprop engine, a turboshaft engine, a ducted turbofan engine, an unducted turbofan engine or an open rotor turbine engine.

The airfoil 232 can include a wall 238 bounding an interior 248. The wall 238 can extend between a leading edge 244 and a trailing edge 246 to define a chordwise direction (C). The wall 238 can further extend between a root 240 and a tip of the fan blade 242 to define a spanwise direction(S). The wall 238 can be a composite wall made of one or more layers of composite material. The one or more layers of material can be applied during the same stage or different stages of the manufacturing of the airfoil 232.

By way of non-limiting example, wall 238 can include at least a polymer matrix composite (PMC) portion or a polymeric portion. The polymer matrix composite can include, but is not limited to, a matrix of thermoset (epoxies, phenolics) or thermoplastic (polycarbonate, polyvinylchloride, nylon, acrylics) and embedded glass, carbon, steel, or Kevlar™ fibers.

The airfoil assembly 230 can further include a spar 236 and a trunnion 234. The spar 236 can extend into the interior 248, or the spar 236 can be formed as a part of or extend from the root 240. The spar 236 can be operably coupled to the trunnion 234. The spar 236 can be any suitable material such as, but not limited to, a composite material. The spar 236 can be a metal composite, for example. The trunnion 234 can include any suitable material such as, but not limited to, a metallic material or a composite material. It will be appreciated that the term composite material can further include metals but with a composite architecture (e.g., a metal matrix composite). In the case of a composite material, the spar 236 and/or the trunnion 234 can be any suitable composite material such as a composite, a laminate skin, a woven or a braided composite, or any other suitable composite.

The airfoil 232 has a span length (L) measured along the spanwise direction S from the root 240 at 0% the span length (L) to the tip of the fan blade 242 at 100% the span length (L). An entirety of the spar 236 can be located below 20% of the span length (L). Alternatively, the spar 236 can extend past 20% of the span length (L).

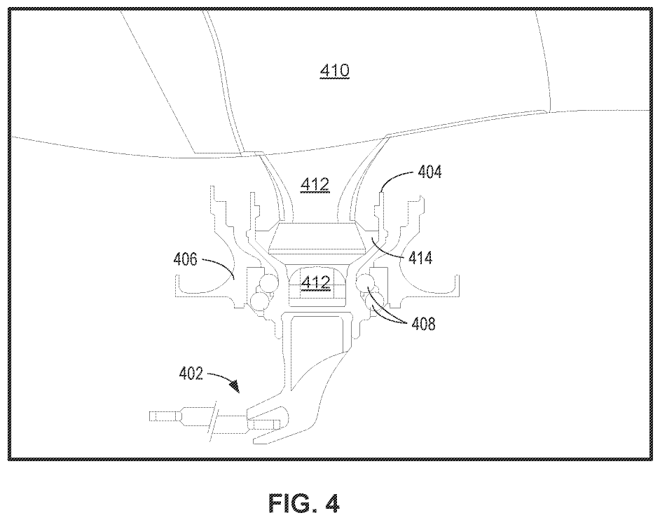

During operation of the airfoil assembly 230, the trunnion 234 can rotate about a pitch axis (Pax) in a rotational direction (Rd). As the spar 236 couples the trunnion 234 to the airfoil 232, rotation of the trunnion 234 in the rotational direction (Rd) causes the airfoil 232 to rotate about the pitch axis (Pax). This rotation can be used to control the pitch of the airfoil assembly 230 such that the airfoil assembly 230 is defined as a variable pitch airfoil assembly. An arm assembly 402 (shown in FIG. 4) actuates in an axial motion to provide twisting to control the pitch of the airfoil assembly 230. The pitch of the airfoil assembly 230 can be varied based on the operation or intended operation of the turbine engine (e.g., the turbine engine 110 of FIG. 1) on which the airfoil assembly 230 is provided. The arm assembly 402 actuates based on a variety of methods such as counterweights, pistons, etc.

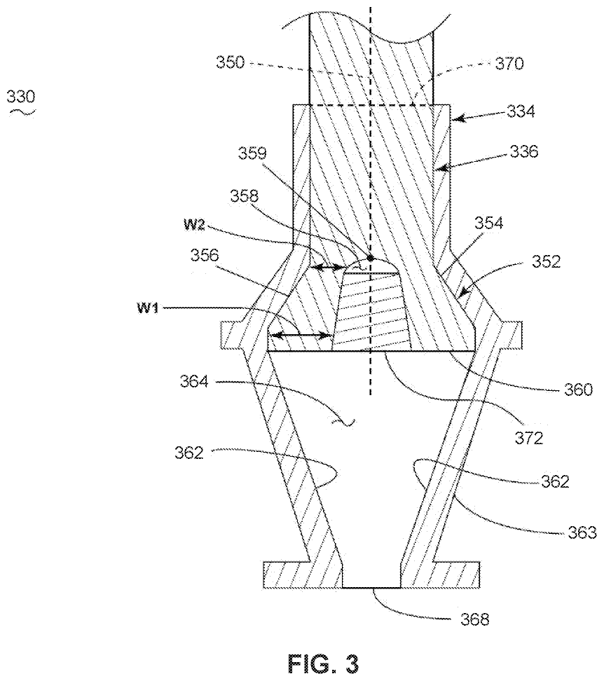

FIG. 3 is a schematic cross-sectional view of the airfoil assembly 230 as seen from sectional line III-III of FIG. 2. The airfoil 232 (FIG. 2) is removed from the airfoil assembly 230 for illustrative purposes.

The trunnion 334 includes a wall 363 with an interior surface 362 at least partially defining a flared socket 364 of the trunnion 334. The flared socket 364 extends between an open top 370 and a bottom 368. The spar 336 extends through the open top 370 and into the interior 248. The bottom 368 can be an open bottom or a sealed/closed off bottom. The flared socket 364 can take a variety of shapes including rectangular or being tapered with at least one flared cross section, as illustrated.

The spar extends along a centerline axis 350 and terminates at a first end 360 within the flared socket 364. The spar 336 includes a furcated tail 352 with a set of branches. As a non-limiting example, the set of branches include a first branch 354 and a second branch 356 that define an intervening gap 358 therebetween. The intervening gap 358 extends axially into the spar 336 and terminates at an apex 359. A width of the first branch 354 and a width of the second branch 356 varies along the axial extent of furcated tail 352. As a non-limiting example, each branch of the set of branches includes a maximum width (W1) and a minimum width (W2) defined as the maximum and minimum radial distances, respectively, between the intervening gap 358 and a radially outward portion of the furcated tail 352 from the intervening gap 358. The maximum width (W1) can be provided axially nearer the first end 360 than the minimum width (W2). As a non-limiting example, the maximum width (W1) can be provided at the first end 360 while the minimum width (W2) can be provided axially nearest the apex 359. The spar 336 can be symmetric or asymmetric about the centerline axis 350.

A wedge 372 can be received within the intervening gap 358. The wedge 372 can be held in place within the intervening gap 358 through frictional contact. Alternatively, the wedge 372 can be coupled to the spar 336 through any suitable coupling method such as, but not limited to, bonding, curing, welding, adhesion, fastening, or the like. The wedge 372 can be any suitable material. As a non-limiting example, the wedge 372 can include a metallic material or a composite material. As a non-limiting example, the airfoil assembly 330 can include the spar 336 including a composite material, the trunnion 334 including a metallic material and the wedge 372 including a metallic material. The wedge 372, as illustrated, is a solid body. However, it will be appreciated that an interior of the wedge 372 or at least a portion of the wedge 372 can be hollow.

The wedge 372 is used to retain the spar 336 within the trunnion 334. When received within the intervening gap 358, the wedge 372 pushes the spar 336, specifically the furcated tail 352 radially outward, with respect to the centerline axis 350, such that the spar 336 is held in contact against the interior surface 362 of the trunnion 334. While a gap is illustrated between the wedge 372 and the spar 336, it will be appreciated that the wedge 372 can be sized to fill an entirety of the intervening gap 358.

FIG. 4 is a schematic illustration of a pitch control assembly to retain a metallic spar of an airfoil in accordance with the teachings of this disclosure. The pitch control assembly includes an arm assembly 402, a trunnion 404, a hub 406, bearings 408, an airfoil 410, a spar 412, and a trunnion assembly retention system 414.

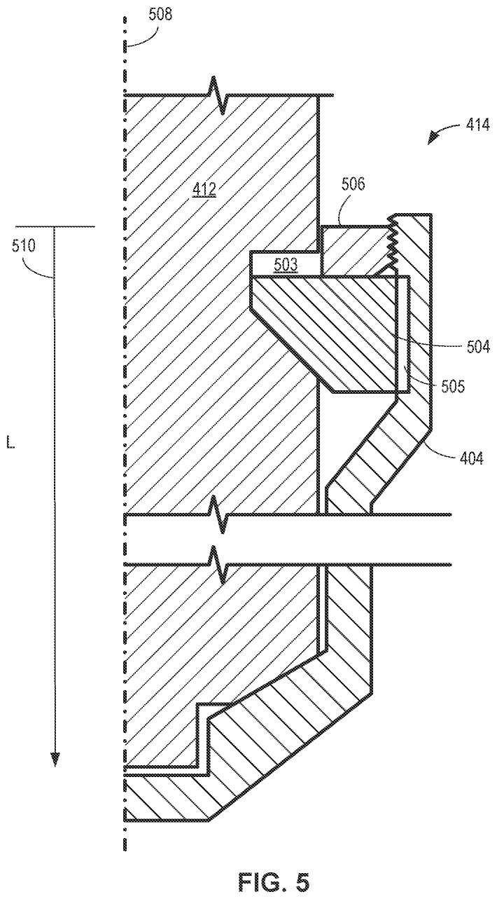

The arm assembly 402 is connected to the trunnion 404, which sits inside a hub 406. The trunnion 404 can rotate due to the presence of bearings 408 in between the trunnion 404 and the hub 406. The trunnion is a retaining system for an airfoil 410 which has a spar 412, which are held in place by assembly pieces, referred to as a trunnion assembly retention system 414 (described in FIG. 5).

In operation, the arm assembly 402 of FIG. 4 operates to rotate the trunnion 404 inside the hub 406 to control the pitch of the airfoil 410. The airfoil 410 is connected to the trunnion 404 by a spar 412, which is held in place by the trunnion assembly retention system 414. The trunnion assembly retention system 414 disclosed herein enables removability of the airfoil 410.

FIG. 5 is a schematic illustration of an example first trunnion assembly retention system 414 of FIG. 4 in accordance with the teachings of this disclosure. The first trunnion assembly retention system 414 includes the spar 412, the trunnion 404, a split ring 504 made of at least two pieces, and a jam nut 506. The spar 412 is notched with a retention pocket 503 for locking the spar 412 in place. In some examples, the retention pocket 503 may be referred to as a means for retention. The trunnion 404 may, in some configurations, include an optional secondary retention pocket 505 to retain the split ring 504.

In assembly, the trunnion assembly retention system 414 allows for the spar 412 to slide into the trunnion 404 (e.g., the means for accepting) until contact is made at a base of the trunnion 404. Once the spar 412 is in place (e.g., contact is made with the bottom of the trunnion 404), the split ring 504 is placed around the spar 412 and contained within the trunnion 404. The split ring 504 slides down the trunnion 404 towards the base of the trunnion 404 until it reaches the retention pocket 503. The split ring 504 slides into the retention pocket 503 (e.g., the means for retention), which prevents the split ring 504 from sliding away from the base of the trunnion 404 while allowing the split ring 504 to anchor the spar 412 within the trunnion 404. As shown in the example of FIG. 5, the trunnion 404 includes a threaded portion, and the jam nut 506 is threaded onto the trunnion 404. In the example of FIG. 5, the trunnion 404, the spar 412, the split ring 504, and the jam nut 506 are revolved around the centerline 508. Any metallic portions of the assembly can be titanium, stainless steel, or nickel, for example.

In operation, the trunnion assembly retention system 414 uses the split ring 504 and jam nut 506 to anchor the spar 412 to the trunnion 404. In effect, the trunnion assembly retention system 414 removably anchors the airfoil 410 (e.g., the means for generating lift) to the hub 406, as shown in FIG. 4. The airfoil 410 is coupled to the spar 412 which slides into the trunnion 404. The trunnion 404 is coupled to the hub 406, as shown in FIG. 4. FIG. 5 demonstrates how the split ring 504 slides around the spar 412 and inside the trunnion 404. The split ring 504 is able to slide along the length of the trunnion 404. In some examples, the split ring 504 is referred to as a means for coupling. The spar 412 has the retention pocket 503 which is shaped to allow the split ring 504 to be contained by the retention pocket 503 so that the split ring 504 may move unidirectionally only towards the base of the trunnion 404 (e.g., the retention pocket 503 prevents the split ring 504 from moving away from a base of the hub 406). The jam nut 506 is threaded inside the trunnion 404 to apply pressure, provide a radial preload to the split ring 504, and restrict outward movement of the split ring 504. Accordingly, the jam nut 506, is also referred to as a nut or a means for restricting. The split ring 504 anchors the spar (and accordingly the airfoil 410, not shown in FIG. 5) further towards the base of the trunnion 404. The split ring 504 helps ensure that a length, L, 510 of the spar 412 is seated into the trunnion 404. The length, L, 510 of the portion of the spar 412 that is seated in the hub 406 as anchored by the split ring 504 is at least greater than the diameter of the airfoil 410 to balance a bending moment reaction. By threading the jam nut 506 down the trunnion 404 to hold components in place, a radial preload is provided to the jam nut 506, inducing a radial reaction at the inner diameter of the trunnion 404.

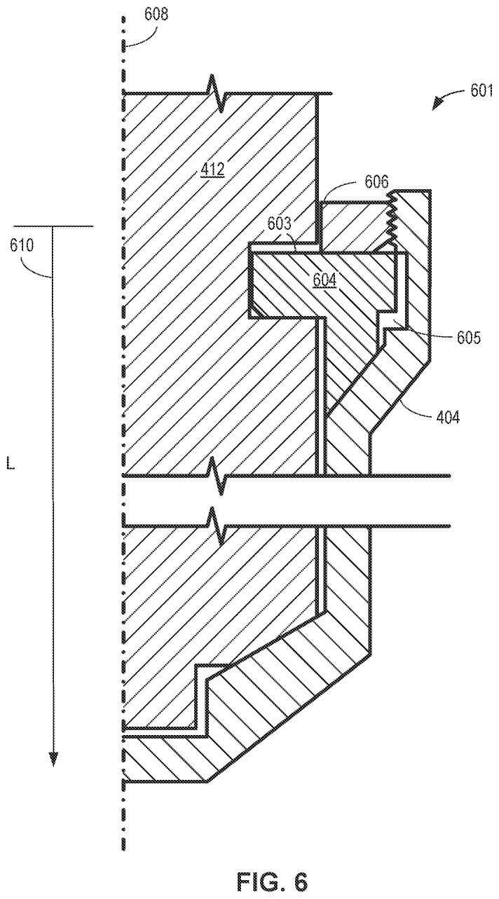

FIG. 6 is a schematic illustration of an example second trunnion assembly retention system 601 of FIG. 4 in accordance with the teachings of this disclosure. The second trunnion assembly retention system 601 includes the trunnion 404, the spar 412, a split ring 604, and a jam nut 606. The spar 412 is notched with a first retention pocket 603 for locking the airfoil 410 in place. The trunnion 404 is also notched with a second retention pocket 605 as a secondary retention mechanism to avoid release. The trunnion 404, the spar 412, the split ring 604, and the jam nut 606 are revolved around the centerline 608.

In assembly, the second trunnion assembly retention system 601 allows for the spar 412 to slide into the trunnion 404. Once the spar 412 is in place, the split ring 604 is placed around the trunnion 404. The split ring slides down the retaining wall towards the trunnion 404 of FIG. 4 until it reaches the first retention pocket 603. The split ring 604 slides into the first retention pocket 603, which prevents the split ring 604 from sliding away from the trunnion 404 (and subsequently the hub 406 of FIG. 4) while allowing the split ring 604 to anchor the airfoil 410 deeper within the trunnion 404. The second retention pocket 605 is shown in this example to avoid release of the split ring 604. As shown in the example of FIG. 6, the trunnion 404 includes a threaded portion, and the jam nut 606 is threaded onto the trunnion 404.

In operation, the components of FIG. 6 operate to removably anchor the airfoil 410 (e.g., the means for generating lift) to the trunnion 404 (e.g., the means for accepting) of FIG. 4. The airfoil 410 slides into the trunnion 404. The split ring 604 (e.g., the means for coupling) slides around the trunnion 404 and is able to slide along the length of the trunnion 404. The airfoil 410 has the first retention pocket 603 (e.g., the means for retention, or retention means) which is shaped to allow the split ring to be contained by the first retention pocket 603 so that the split ring 604 may move unidirectionally only towards the hub 406 (e.g., the first retention pocket 603 prevents the split ring 604 from moving away from the hub 406 of FIG. 4). The jam nut 606 (e.g., the means for restricting) is threaded onto the trunnion 404 to apply pressure to the split ring 604 and restrict outward movement of the split ring 604. The split ring 604 anchors the airfoil 410 and the spar 412 further into the trunnion 404 (and subsequently the hub 406 of FIG. 4). The split ring 604 helps ensure that a length, L, 610 of the airfoil 410 is seated into the trunnion. The length L of the portion 610 that is seated in the trunnion 404 as anchored by the split ring 604 is at least greater than the diameter of the airfoil 410 to balance a bending moment reaction. By threading the jam nut 606 down the trunnion 404 to hold components in place, a radial preload is provided to the jam nut 606, inducing a radial reaction at the inner diameter of the trunnion 404 of FIG. 4.

From the foregoing, it will be appreciated that example systems, apparatus, articles of manufacture, and methods have been disclosed that allow for the retention and removability of a fan blade from a spar and hub. Improved retention is provided due to a radial preload provided by a jam nut, which positions the blade based on a particular ratio of blade length to blade diameter. This improved positioning provides improved bending moment reaction.

Further aspects of the disclosure are provided by the subject matter of the following clauses:

An example apparatus to attach an airfoil to a hub, the apparatus comprising a trunnion coupled to the hub, the trunnion to receive a spar of the airfoil, the spar forming a base of the airfoil, the spar positioned with respect to the trunnion so that a portion of the spar having a length greater than a diameter of the airfoil is retained within the trunnion to react a moment through the length of the airfoil retained within the trunnion, a split ring around an inside of the trunnion, the split ring aligned with a notch on the airfoil, the notch on the airfoil shaped to allow the split ring to move towards a base of the trunnion, and a nut removably coupled to the trunnion, the nut positioned with respect to the split ring to apply pressure to the split ring to restrict movement of the spar with respect to the trunnion.

The example apparatus of any preceding clause, wherein the airfoil has a retention pocket to retain the split ring.

The example apparatus of any preceding clause, wherein the trunnion has a retention pocket to retain the split ring.

The example apparatus of any preceding clause, wherein the split ring includes at least two pieces.

The example apparatus of any preceding clause, wherein the trunnion is made up of at least one of titanium, stainless steel, or nickel.

The example apparatus of any preceding clause, wherein the pressure applied to the split ring by the nut is a radial preload inducing a radial reaction at an inner diameter of the trunnion.

The example apparatus of any preceding clause, wherein the trunnion is coupled to an arm, the arm to control a pitch of the airfoil by rotating the trunnion within the hub.

An example apparatus to accept an airfoil and couple the airfoil to a hub in an engine, the apparatus comprising a trunnion coupled to the hub, the trunnion to receive a spar of the airfoil, a split ring around an inside of the trunnion, and a nut removably coupled to the trunnion, the nut positioned further from a base of the trunnion than the split ring.

The example apparatus of any preceding clause, wherein the trunnion has a retention pocket to retain the split ring.

The example apparatus of any preceding clause, wherein the split ring includes at least two pieces.

The example apparatus of any preceding clause, wherein the trunnion is made up of at least one of titanium, stainless steel, or nickel.

The example apparatus of any preceding clause, wherein the split ring is shaped to fit within a retention pocket on the airfoil.

The example apparatus of any preceding clause, wherein the nut applies a pressure to the split ring to prevent the split ring from sliding away from the base of the trunnion, the pressure stemming from a radial preload reacting at an inner diameter of the trunnion.

The example apparatus of any preceding clause, wherein the trunnion is coupled to an actuating arm, the actuating arm to control a pitch of the airfoil by rotating the trunnion within the hub.

An example apparatus comprising a first means for accepting a second means for generating lift, a third means for coupling the second means to the first means, and a fourth means for restricting the third means from moving out of the first means, the fourth means removably coupled to the first means.

The example apparatus of any preceding clause, wherein the second means is shaped to fit within a retention means in the first means.

The example apparatus of any preceding clause, wherein the second means is shaped to fit within a retention means in the second means.

The example apparatus of any preceding clause, wherein the second means includes at least two pieces.

The example apparatus of any preceding clause, wherein the third means is made up of at least one of titanium, stainless steel, or nickel.

The example apparatus of any preceding clause, further including a fifth means, the fifth means to rotate the first means to control a pitch associated with the second means. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to attach an airfoil to a hub, the apparatus comprising:
a trunnion coupled to the hub;
a spar forming a base of the airfoil, the spar positioned with respect to the trunnion so that a portion of the spar having a length greater than a diameter of the airfoil is retained within the trunnion to react a moment through the length of the airfoil retained within the trunnion;
a split ring around an inside of the trunnion, the split ring aligned with a notch on the airfoil, the notch on the airfoil shaped to allow the split ring to move towards a base of the trunnion; and
a nut removably coupled to the trunnion, the nut positioned with respect to the split ring to apply pressure to the split ring to restrict movement of the spar with respect to the trunnion.

2. The apparatus of claim 1, wherein the airfoil defines a retention pocket to retain the split ring.

3. The apparatus of claim 1, wherein the trunnion defines a retention pocket to retain the split ring.

4. The apparatus of claim 1, wherein the split ring includes at least two pieces.

5. The apparatus of claim 1, wherein the trunnion is made up of at least one of titanium, stainless steel, or nickel.

6. The apparatus of claim 1, wherein the pressure applied to the split ring by the nut is a radial preload inducing a radial reaction at an inner diameter of the trunnion.

7. The apparatus of claim 1, wherein the trunnion is coupled to an arm, the arm to control a pitch of the airfoil by rotating the trunnion within the hub.

8. An apparatus to accept an airfoil and couple the airfoil to a hub in an engine, the apparatus comprising:
a trunnion coupled to the hub, the trunnion to receive a spar of the airfoil;
a split ring around an inside of the trunnion; and
a nut removably coupled to the trunnion, the nut positioned further from a base of the trunnion than the split ring.

9. The apparatus of claim 8, wherein the trunnion defines a retention pocket to retain the split ring.

10. The apparatus of claim 8, wherein the split ring includes at least two pieces.

11. The apparatus of claim 8, wherein the trunnion is made up of at least one of titanium, stainless steel, or nickel.

12. The apparatus of claim 8, wherein the split ring is shaped to fit within a retention pocket on the airfoil.

13. The apparatus of claim 8, wherein the nut applies a pressure to the split ring to prevent the split ring from sliding away from the base of the trunnion, the pressure stemming from a radial preload reacting at an inner diameter of the trunnion.

14. The apparatus of claim 8, wherein the trunnion is coupled to an actuating arm, the actuating arm to control a pitch of the airfoil by rotating the trunnion within the hub.

15. An apparatus comprising:
a first means for accepting a second means for generating lift;
a third means for coupling the second means to the first means; and
a fourth means for restricting the third means from moving out of the first means, the fourth means removably coupled to the first means.

16. The apparatus of claim 15, wherein the second means is shaped to fit within a retention means in the first means.

17. The apparatus of claim 15, wherein the second means is shaped to fit within a retention means in the second means.

18. The apparatus of claim 15, wherein the second means includes at least two pieces.

19. The apparatus of claim 15, wherein the third means is made up of at least one of titanium, stainless steel, or nickel.

20. The apparatus of claim 15, further including a fifth means, the fifth means to rotate the first means to control a pitch associated with the second means.
